(19) United States
(12) Patent Application Publication
(10) Pub. No.: US 2010/0187741 A1
(43) Pub. Date: Jul. 29, 2010

(54) Disposable cutting board

(76) Inventor: Alice Marie Fischer, Kearny, NJ (US)

Correspondence Address: Alice Marie Fischer, 217 Beech Street, Kearny, NJ, 07032, US

(21) Appl. No.: 12/321,944

(22) Filed: Jan. 27, 2009

(51) Int. Cl. B23Q 3/00

(52) U.S. Cl. 269/289 R

(57) ABSTRACT

This invention will provide the consumer with a sanitary and effective means of preparing. This invention also makes it easy to discard and clean-up the by-products associated with the preparation of such foods through its waste disposal enclosure bags. The Disposable Cutting Board has a sturdy-base surface designed to work on a flat surface of the same size or larger and/or in conjunction with a preexisting cutting board. The sturdy base surface is structured to withstand the cutting, slicing, dicing and other means necessary in the preparation of and serving of food products. The Disposable Cutting Board has a leak resistant waste disposal enclosure bag, which secures the disposable cutting board for easy one step clean-up- just close the fastener, for discard of-the by-products together with the Disposable Cutting Board.

### BACKGROUND OF THE INVENTION

The use of cutting boards in the preparation of food products has been well established over the years. A variety of cutting boards have been manufactured from different materials in different sizes. Cutting boards are standard in most households and used by the consumer as a standard kitchen tool. They are designed for everyday use and each provides instructions for use, safety in use and cleaning directions. These cutting boards, however useful, lack in function with regard to complete sanitary preparation of foods, as they completely rely on the consumer with regard to the sanitary safety in cleaning the cutting boards. They also lack in design for the ease in clean-up of and disposal of food by-products and the liquid waste created by such foods. The clean-up and disposal of by-products are regarded as standard aspects in the preparation of food products. Some examples of food products which would produce by-products related to such waste would be; meats, poultry, fish, produce, etc.

### BRIEF SUMMARY OF THE INVENTION

A Disposable Cutting Board designed for sanitary preparation of food products and ease in disposal of various food by-products. This Disposable Cutting Board is specifically designed to create a complete sanitary environment upon which foods can be prepared for cooking and serving. This Disposable Cutting Board is designed to hold the by-products during the preparation of various food products, through the waste disposal enclosure bag, which is a necessary part of the Disposable Cutting Board. This Disposable Cutting Board is leak resistant and can be used for either hot or cold various foods.

### BRIEF DESCRIPTION OF THE SEVERAL VIEWS OF THE DRAWING

FIG. 1

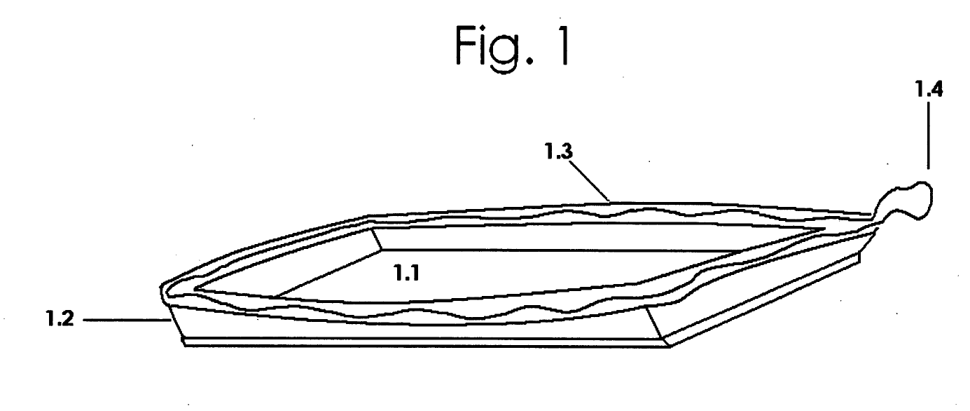

A Disposable Cutting Board for food preparation and/or serving comprising:

1.1 The Disposable Cutting Board will have sturdy base surface secured by a waste disposal enclosure bag.

1.2 The waste disposal enclosure bag holds the food by-products during food preparation.

1.3 A common fastener secures the waste disposal enclosure bag.

1.4 A common fastener closes the waste disposal enclosure bag for easy discard.

FIG. 2

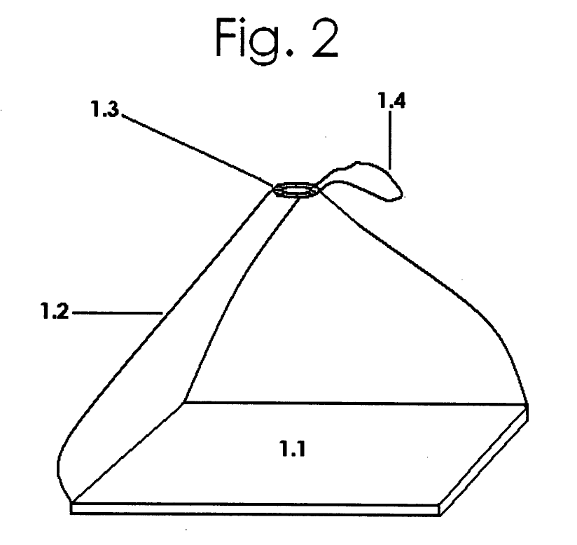

This drawing demonstrates the closure of the Disposable Cutting Board's waste disposal enclosure bag for easy discard of the by-products, together with the Disposable Cutting Board.

### DETAILED DESCRIPTION OF THE INVENTION

A Disposable Cutting Board is structured and designed to be used on a flat surface or in conjunction with another cutting board. This Disposable Cutting Board has a top base surface designed to support the slicing, dicing, cutting and other various steps necessary in the preparation of and/or serving of food products. While the bottom base surface would be structured and designed to prevent movement during use. This Disposable Cutting Board is designed with a leak resistant waste disposal enclosure bag. This bag is designed to hold-the waste associated with the preparation of the food product. This waste disposal enclosure bag, which is a complete part of this Disposable Cutting Board, is designed with a common fastener to close the bag for ease in disposal of the food by-products. Also, this bag is a complete and necessary component of the Disposable Cutting Board function.

1- a Disposable Cutting Board designed to assist in the sanitary preparation of and serving of food both indoor and outdoor.

2- has a top and bottom base surface and is comparable in size of length and width of a standard cutting board, however, the Disposable Cutting Board can be manufactured in smaller or larger dimensions (i.e., sizes, shapes and/or thickness).

3- can be used for either hot or cold food preparation and/or serving of food products.

4- can be used alone on a flat surface, or in conjunction with a preexisting cutting board.

5. the top and bottom base surface thickness can vary depending upon the material used in manufacture to support proper function.

6- has a top and bottom base surface-which is made of a disposable plastic; however, this disposable-base surface can be manufactured of other various plastic materials, including, but not limed to various paper by products.

7- is structured to withstand the necessary use in cutting, slicing, dicing, and other necessary means used in the preparation of and serving of food products.

8- has a waste disposal enclosure bag which supports Disposable Cutting Board function.

9- uses a waste disposal enclosure bag made of plastic; however this waste disposal enclosure bag can be made of various plastic products, and/or including, but not limited to, various paper by-products.

10- will aide in clean-up of and sanitary preparation of food products [i.e.; poultry, fish, meats, produce, etc.].

11- a common fastener can be used to close the waste disposal enclosure bag.

12- the waste disposal enclosure bag is designed to provide an easy one-step clean up of the by-products, along with the Disposable Cutting Board—just close the fastener.

13- other materials may be required to achieve the necessary strength, durability, leak résistance, and safety requirements for this device, and are not limited to paper and/or plastic materials in manufacture to ensure the proper function of this invention.

14- should be light weight, easy to use and create convenience in use through an easy one step clean-up process and convenience of use through cost effective manufacture and availability for the consumer.

15- can have other uses within the marketplace for services that would require the convenience in use and convenience of use function that this invention can provide for the consumer.
